(19) United States
(12) Patent Application Publication
(10) Pub. No.: US 2004/0186751 A1
(43) Pub. Date: Sep. 23, 2004

(54) Method for providing insurance and an insurance policy protecting persons against malpractice or willful misconduct by a professional

(76) Inventors: William Thomas Colavito, Woodbine, NJ (US); Martin S. Ettin, Cherry Hill, NJ (US); Rob Saltzman, Cherry Hill, NJ (US)

Correspondence Address: CAESAR, RIVISE, BERNSTEIN,, COHEN & POKOTILOW, LTD., 11TH FLOOR, SEVEN PENN CENTER, PHILADELPHIA, PA, 19103-2212, US

(21) Appl. No.: 10/391,696

(22) Filed: Mar. 19, 2003

(51) Int. Cl. G06F 17/60

(52) U.S. Cl. 705/4

(57) ABSTRACT

A method of providing insurance to pay to an insured individual in the event of his/her personal injury due to negligence and/or professional malpractice. The insurance policy could cover one or more categories of loss, such as, but not limited to, non-economic loss(es), pain and suffering, etc., arising from negligence, professional malpractice or other actionable cause.

### FIELD OF THE INVENTION

The invention relates generally to insurance policies and the method of providing insurance to protect injured persons from inadequate compensation caused by limitations imposed by applicable law on lawsuit recoveries. More particularly, this invention relates to insurance policies and the method of providing insurance to pay the difference between any such legal limitation and the actual award or jury verdict in favor of the covered person.

### BACKGROUND OF THE INVENTION

As society has become more concerned about containing costs for healthcare and other professional services, increasing scrutiny has been directed to professional and healthcare insurance coverage costs. As a means of containing such costs, legislation is or is about to be enacted in various jurisdictions limiting lawsuit recoveries. While the extent to which such limitations will be an effective healthcare cost-containment device is debated, such limitations clearly result in some injured persons receiving inadequate compensation for their demonstrable injuries or damages or less compensation than they would otherwise receive absent the limitations.

Although these problems affect various different lay and professional fields as discussed above, the problem is particularly acute in the case of medical malpractice claims and litigation. Accordingly, the remainder of this specification shall be addressed primarily to such malpractice claims, litigation, and insurance, it being understood that the discussion applies equally well to other kinds of claims, litigation and insurance, whether predicated upon allegation(s) of professional liability or other negligence. Although applicable statutes, court rules, regulations and other elements of the judicial process in every jurisdiction of the United States provide mechanisms by which injured persons may seek and obtain recovery for their injuries, such recoveries may be limited by applicable law(s) enacted to contain healthcare costs. I n such circumstances, injured persons are left without a means to recover the difference between such limitation and the amount of the actual verdict or award. For this reason, it would be desirable to be able to provide an improved method of providing insurance coverage to such persons.

### SUMMARY OF THE INVENTION

In accordance with this invention, there is provided a method of application for, issuance and administration of a policy of insurance designed to provide coverage for the difference between any legal limitation on a jury verdict or other award predicated upon professional negligence or malpractice and the policy limits, together with a method for determining the applicability and amount of coverage. Applications are received from persons in contemplation of the provision of professional services whose efficacy is dependent upon the professional's adherence to the applicable standard of care, in default of which the person suffers actionable injuries. A policy of insurance could be issued which would provide coverage, subject to payment of the premium therefor, enumerated contingencies, restrictions, limitations, exclusions, deductibles and/or co-payments, for the difference between any legal limitation on a lawsuit verdict award and the actual amount of the award.

Upon the occurrence of an adverse and actionable result arising from the negligent provision of professional services, and the insured's recovery of a final, non-appealable verdict or award in an amount in excess of an applicable legal limitation thereon, the insurance carrier pays to the insured, subject to the policy provisions, the difference between such limitation and the actual amount of the verdict or award in favor of the insured, up to the policy limits.

### DESCRIPTION OF THE DRAWING

To facilitate an appreciation of the advantages and objects of the invention, a more particular description of the invention will be rendered by reference to a specific embodiment thereof which is illustrated in the annexed drawings. Understanding that the drawings depict only a typical embodiment of the invention and should not be deemed to limit its scope, a preferred embodiment of the invention will be described and explained with further specificity through the annexed drawings.

FIG. 1 is a flow diagram representing one, exemplary preferred embodiment of a process according to the invention from application for insurance through completion of claims administration;

FIG. 2 is a flow diagram of the Application and Policy Issuance module of the process shown in FIG. 1, including certain underwriting and other criteria according to the invention; and

FIG. 3 is a flow diagram of the Claims Administration module of the process of FIG. 1.

### DETAILED DESCRIPTION OF THE PREFERRED EMBODIMENT

According to the present invention, the incidence of injured persons receiving inadequate compensation for injuries and/or damages caused by negligence is reduced because of the availability of insurance coverage for the difference between an applicable legal limitation on a verdict or award in favor of such persons and the amount of the verdict or award. Potential applicants for insurance could be persons contemplating a particular medical procedure or those interested in protection generally from the risks presented by limitations that have been or are about to be enacted in various jurisdictions upon negligence verdicts or awards. Due to such limitations on lawsuit payouts, injured persons with viable cases may be unable to retain counsel to prosecute their case. For example, as reported in the New York Times on Mar. 5, 2003, in California, where lawsuit recoveries have been limited since 1975, consumer advocates and lawyers groups contend that many legitimate cases are not being pursued. In this legislative climate and under existing and developing market conditions, it would therefore be desirable to provide a mechanism, accomplished by the present invention, for fully compensating such injured persons consistent with the goals of the legislation imposing such limitations.

The insurance of the invention could be offered as a separate insurance policy to purchase and/or renew, or as a rider to another policy, such as, for homeowners' or automobile insurance.

Once an applicant has been accepted for coverage under a variant of insurance policy according to the invention, a policy or rider is issued and the transaction(s), procedure(s) or occurrence(s) as well as any professionals known to be involved are entered into the insurance carrier's computer system. In addition to all the usual processes that would typically obtain in connection with the application for and issuance of an insurance policy, the invention would determine the underwriting risks with reference to such factors as the nature of the contemplated procedure and, the claims record of any professionals anticipated to be involved, the ascertainable incidence of resulting injuries from such procedure, the potential for a negligence verdict or award in an amount in excess of an applicable legal limitation thereon, and other factors. In a typical preferred embodiment of the invention, an applicant would apply for coverage in contemplation of a particular medical procedure, such as surgery, elective or otherwise. According to the invention, the system would determine the appropriate premium price for a policy providing coverage for a verdict or award resulting from the negligent performance of such procedure, beyond an applicable legal limitation on such verdict or award, up to the policy limits. In a preferred embodiment, eligibility for benefits under the policy regarding a particular claim would be that the underlying negligence or malpractice action proceed through entry of a final, non-appealable verdict or award in favor if the insured, and not earlier settled, terminated or otherwise discontinued. Almost any person contemplating a medical procedure would likely be eligible for coverage. At one extreme is the “good” applicant, who enjoys good health and is applying for coverage as a rider to a homeowner's insurance policy. Such a person is a good risk for insurance because he/she will rarely make a claim for benefits. At the opposite extreme is the “bad” applicant, who is generally unhealthy and is making application for a stand-alone policy in contemplation of a particular procedure known to involve a substantial risk of complications or adverse results and to be performed by a physician having a prior record of unsuccessfully defending malpractice claims arising from such or similar procedures. Such a person is also a good risk for insurance because he/she would not be eligible for benefits if the he/she does not prevail in a negligence lawsuit or if the case is settled or otherwise discontinued before entry of a final, non-appealable verdict or award.

In an alternative embodiment of the invention, coverage could be provided notwithstanding that the underlying negligence and/or malpractice lawsuit is discontinued prior to entry of a final, non-appealable verdict or award. In such an embodiment, an objective review of the value of the covered persons covered injuries and/or damages could be conducted by a panel of doctors and lawyers retained by the insurance carrier. The panel could be maintained by the carrier in-house, but more preferably, to encourage objectivity, is comprised of independent professionals contracted for such purpose. Alternatively, it may be possible to develop sets and subsets of criteria that could allow for an objective determination to be made initially by a computer predicated upon, e.g., responses to questionnaires developed for such purpose. If a computer is employed to make an initial determination of value, then preferably an opportunity could be provided for human review of such determination.

Therefore, in a preferred embodiment, any premium charged to policyholders would be nominal/minimal, in consideration of the statistical probability of actionable negligence resulting in a final verdict or award, thereby facilitating coverage without negatively impacting other components of the healthcare industry and simultaneously advancing the salutary purposes of the legislation imposing limits on lawsuit recoveries. Premium payments for insurance according to the invention would preferably be available to offset the costs to the insurer of claims administration in connection with other negligence and/or malpractice claims.

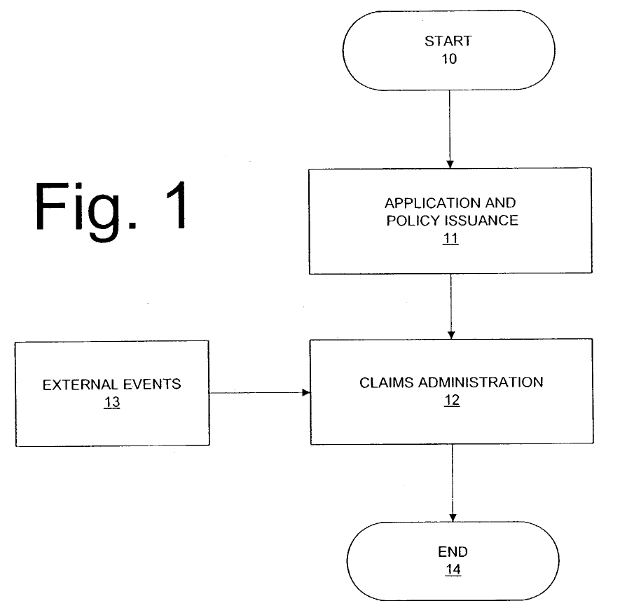

The invention will now be described with reference to FIGS. 1-3. To that end as can be seen FIG. 1 depicts an overview of a preferred embodiment of the process for administering the plan of insurance according to the invention. The process begins at the Start block 10 and proceeds to process module block, called the “Application and Policy Issuance” module 11, which is described and explained in further detail below. Briefly, in module 11, an application for insurance is made and it is determined which is more appropriate, a stand-alone policy in contemplation of a particular transaction, occurrence or procedure, a finite series of one or more of the foregoing, or as a rider to an existing policy, e.g., for homeowners' insurance. Upon completion of the underwriting and pricing processes, the premium is collected and the appropriate policy or rider is issued.

Thereafter, the process proceeds to process block module 12, entitled “claims Administration” upon the occurrence of external events at 13, e.g.,______. Briefly, in module 12, a covered person makes application for benefits upon the occurrence of external events 13, and a determination is made regarding the applicability of coverage and benefits. Such determination having been made, whether to deny coverage under the policy of to issue payment thereunder, the process ends at 14.

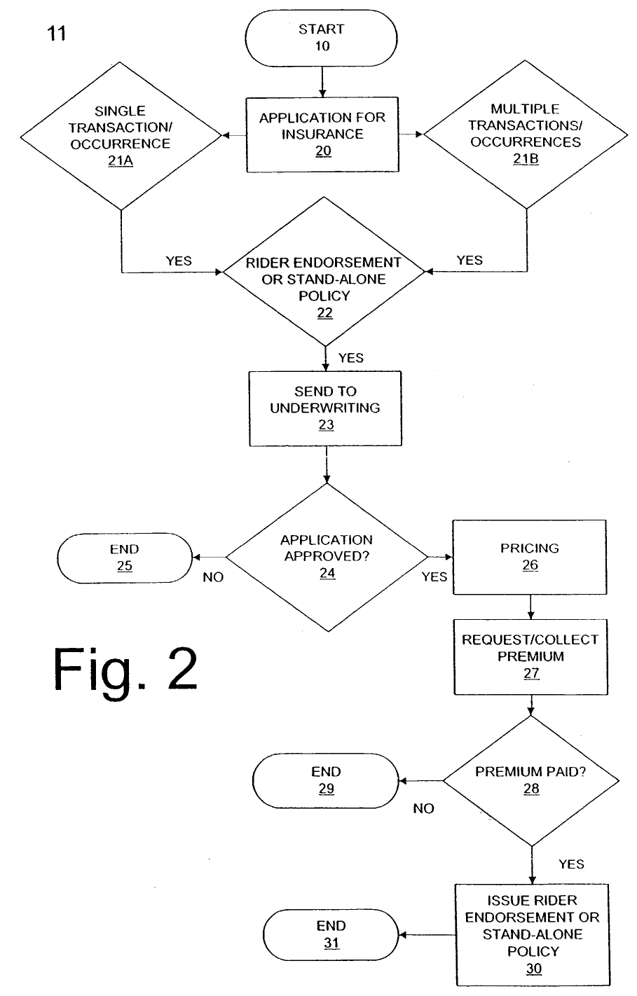

The Application and Issuance module 11 is depicted in more detail in FIG. 2. As can be seen therein, the process of module 11 begins at block 20, wherein an applicant manifests an inclination to purchase a policy according to the invention. At decision block 21A-21B, a determination is made that the contemplated insurance is for a particular transaction, occurrence, procedure or series thereof or, alternatively, whether indeterminate coverage for a class of transaction(s), occurrence(s) or procedure(s) is contemplated. The process of module 11 then proceeds to decision block 22, at which time a determination is made to issue either a stand-alone policy or a rider to an existing policy of, e.g., homeowners, insurance. The process of module 11 then proceeds to process block 23 for underwriting, where a risk management analysis is conducted to determine whether or not the applicant qualifies for issuance of the policy determined to be appropriate by decision block 22. Whether performed in the more traditional manner, i.e., manually by actuaries, or by an automated process, e.g., by computer predicated upon responses to questionnaires developed for such purpose in conjunction with known statistical data regarding the procedure and/or professionals known to be involved, information gathered thus far in the process would constitute the basis for the underwriting decision rendered at the conclusion of process of block 23.

The underwriting step shown by process block 23 can be abbreviated or obviated, particularly where the application is for a rider to an existing policy, in consideration of the relatively minimal risk involved. Specifically, for the reasons previously expressed, it may be that all such applicants constitute good underwriting risks for insurance according to the invention. In this alternative, underwriting step of block 23 could be avoided altogether and the process proceed directly to a pricing step shown by process block 26.

An underwriting determination having been made at the process block 23, or automatically approved under the alternative described in the foregoing paragraph, the process of module 11 then proceeds to decision block 24 wherein a final determination is made to issue a policy or rider. If the underwriting analysis produces a negative result and the carrier declines to issue a policy or rider, the process ends as shown by terminator block 25. If at decision block 24 the application is approved, the process of module 11 proceeds to process block 26 for pricing. Once the pricing for the contemplated insurance premium is determined, the process of module 11 proceeds to the step shown by process block 27 wherein the premium is requested/collected. If at decision block 28 the premium is not collected, the process of module 11 ends at terminator block 29. If at decision block 28 the premium is collected, the process of module 11 proceeds to process block 30 for issuance of the stand-alone policy or rider. Upon issuance of the policy or rider at the block 30, the process of module 11 ends at terminator block 31.

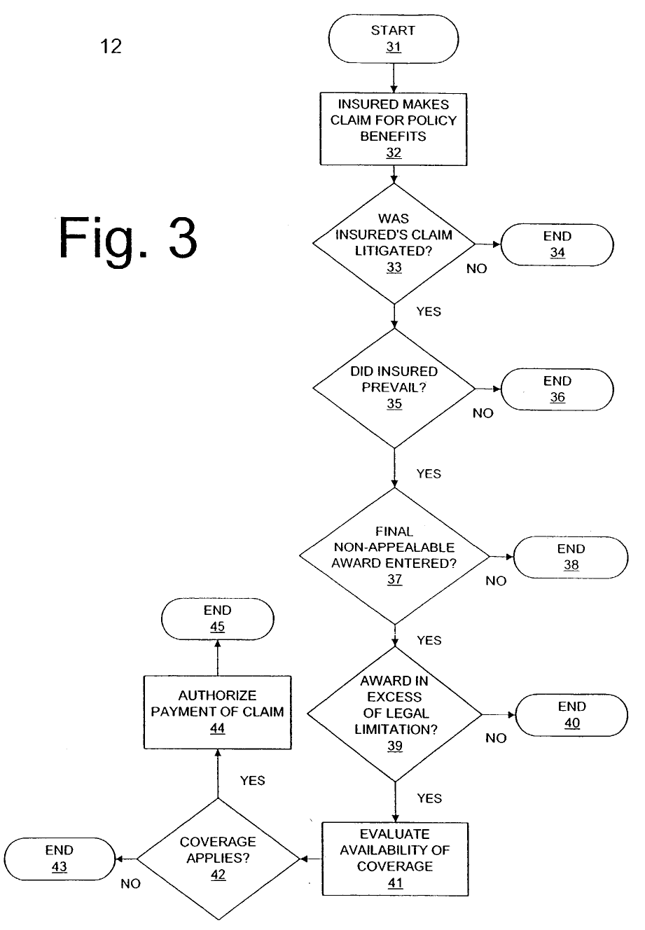

FIG. 3 depicts claims Administration module 12, pursuant to an illustrative example (not to be construed as a limitation on the scope of the invention) of external events 13. The process of the claims Administration module 12 begins in response to terminator block 31 (now designated as start block 31) and proceeds to process block 32 wherein an application for benefits under the policy or rider issued at step 30 is made. At decision block 33 it is determined whether or not the insured's negligence or malpractice claim was litigated. If not, the process ends at terminator block 34, unless the alternative embodiment previously described obtains, wherein the coverage is provided notwithstanding the settlement, termination or otherwise early discontinuance of the lawsuit.

the process of the claims Administration module 12 then proceeds to decision block 35, wherein it is determined whether or not the insured prevailed in the underlying litigation. If not, the process of module 12 ends at termination block 36, unless the alternative embodiment previously described obtains, wherein the coverage is provided notwithstanding the settlement, termination or otherwise early discontinuance of the lawsuit.

The process of module 12 then proceeds to decision block 37, wherein it is determined whether or not a final, non-appealable verdict or award was entered in favor of the insured. If not, the process ends at termination block 38, unless the alternative embodiment previously described obtains, wherein the coverage is provided notwithstanding the settlement, termination or otherwise early discontinuance of the lawsuit.

The process of module 12 then proceeds to decision block 39, wherein it is determined whether the verdict or award exceeds an applicable legal limitation thereon. Such a determination includes, but is not limited to, considerations of the nature and scope of such limitation(s), the applicability of any appropriate credits or offsets, or, in an alternative embodiment, the availability of benefits under any funds established for compensation in connection with catastrophic injuries. If the verdict or award does not exceed an applicable limitation thereon, or if reduced by credits, offsets or, in an alternative embodiment, the availability of a catastrophic injury fund, the process of module 12 ends at termination block 40.

The process of module 12 then proceeds to process block 41 wherein the availability of coverage under the policy or rider issued at process block 30 is determined, predicated upon such factors as lapse in coverage for nonpayment of the premium or other criteria developed for this purpose. The process of module 12 then proceeds to decision block 42 for a determination of the applicability of coverage, predicated upon such factors as honesty in the application process, applicability of any exclusions, restrictions, credits, offsets or other limitations on coverage and/or other criteria developed for this purpose. If coverage is determined to be inapplicable, the process of module 12 ends at termination block 43.

The process of module 12 then proceeds to process block 44, where, upon a determination at decision block 42 that coverage applies, authorization is made for extension of benefits under the policy, more specifically, for payment of the difference between the limitation on such verdict or award and the amount thereof, up to the policy limits and pursuant to the policy terms. The process thereafter ends at termination block 45.

As should be appreciated from the foregoing the subject invention entails a plan of insurance/reinsurance/excess insurance/gap insurance coverage/supplemental insurance provided to the public, possibly as an umbrella vehicle, endorsement to an existing policy of homeowners' or other insurance, or a stand-alone policy to purchase and/or renew, providing coverage for one or more enumerated occurrences. The plan of insurance pays to the insured, subject to enumerated exclusions, reservations, deductibles and/or subrogation rights, and/or credits for catastrophic loss or governmental or similar funds established to provide further compensation for such injuries, the difference between any limitation on the insured's recovery in a personal injury, negligence and/or professional malpractice lawsuit provided for by applicable law and the actual amount of a verdict, arbitration, award, or other final and non-appealable determination of the amount necessary or appropriate to compensate the insured for injuries at issue in such lawsuit without regard for such legal limitation, up to the policy limits. An applicant, once accepted by the insurance carrier, would receive a policy of insurance covering one or more categories of loss, such as, but not limited to, noneconomic loss(es), pain and suffering, etc., arising from negligence, professional malpractice or other actionable cause. Coverage and premium price could be contingent upon the nature of the contemplated transaction(s), procedure(s) or occurrence(s), specialty of any professionals or other tortfeasors involved, the number of transaction(s), procedures or occurrences whose adverse consequences are to be covered, etc., and coverage could be provided notwithstanding the insolvency of any primary insurer(s) or the availability/unavailability of other potential sources of recovery.

Without further elaboration the foregoing will so fully illustrate our invention that others may, by applying current or future knowledge, adopt the same for use under various conditions of service.

We claim:

1. A method of providing insurance to pay to an insured person in the event of his/her personal injury, comprising:
(A) a person making application to an insurance carrier for an insurance policy in contemplation of the provision of professional services by a professional entity to the person, the efficacy of the professional services being dependent upon the professional entity's adherence to applicable standard(s) of care, said insurance policy to pay the person an amount in the event that he/she is injured due to the willful misconduct, negligence and/or professional malpractice of the professional entity; and
(B) the insurance provider issuing said insurance policy if the person's application meets the insurance provider's acceptance standards.

2. The method of claim 1 said acceptance standards comprise payment of a premium for the insurance policy, and/or enumerated contingencies, restrictions, limitations, exclusions, deductibles and/or co-payments.

3. The method of claim 1 wherein the amount payable to the insured person by the insurance carrier under the insurance policy is established by the difference between any legal limitation on a jury verdict or other award predicated upon the willful misconduct, negligence or professional malpractice of the professional entity and the insurance policy limits.

4. The method of claim 1 wherein the amount payable to the insured person by the insurance carrier under the insurance policy is established by the difference between any legal limitation on a lawsuit verdict award and the actual amount of the award.

5. The method of claim 1 wherein upon the occurrence of an adverse and actionable result arising from the willful misconduct or negligent provision of professional services, and the insured person's recovery of a final, non-appealable verdict or award in an amount in excess of an applicable legal limitation thereon, the insurance carrier pays to the insured, subject to the policy provisions and credit for catastrophic or other governmental or similar funds established to provide compensation for such claims, the difference between such limitation and the actual amount of the verdict or award in favor of the insured, up to the policy limits.

6. An insurance policy to pay to an insured person in the event of his/her personal injury, comprising a legally binding instrument arranged to be taken out from an insurance carrier by a person in contemplation of the provision of professional services by a professional entity to the person, the efficacy of the professional services being dependent upon the professional entity's adherence to the applicable standard(s) of care, said insurance policy being arranged to pay the insured person an amount in the event that he/she is injured due to the willful misconduct, negligence and/or professional malpractice of the professional entity.

7. The insurance policy of claim 6 wherein the issuance of said policy require acceptance by the insurance carrier based on acceptance standards of the insurance carrier, said standards comprising payment of a premium for the insurance policy, and/or enumerated contingencies, restrictions, limitations, exclusions, deductibles and/or co-payments.

8. The insurance policy of claim 6 wherein the policy includes an amount payable to the insured person by the insurance carrier, said amount payable being established by the difference between any legal limitation on a jury verdict or other award predicated upon the willful misconduct, negligence or professional malpractice of the professional entity and the insurance policy limits.

9. The insurance policy of claim 6 wherein the policy includes an amount payable to the insured person by the insurance carrier, said amount payable being established by the difference between any legal limitation on a lawsuit verdict award against the professional entity and the actual amount of the award.

10. The insurance policy of claim 6 wherein the policy includes an amount payable to the insured person by the insurance carrier upon the occurrence of an adverse and actionable result arising from the willful misconduct or negligent provision of professional services by the professional entity, and the insured person's recovery of a final, non-appealable verdict or award in an amount in excess of an applicable legal limitation thereon, whereupon the insurance carrier is required to pay to the insured person, subject to the policy provisions, the difference between such limitation and the actual amount of the verdict or award in favor of the insured person, up to the policy limits.
